(19) United States
(12) Patent Application Publication
(10) Pub. No.: US 2016/0009439 A1
(43) Pub. Date: Jan. 14, 2016

(54) TAB STYLE CONTAINER WITH INTERNAL SUPPORT STRUCTURES

(71) Applicant: Rock-Tenn Shared Services, LLC, Norcross, GA (US)

(72) Inventors: Maureen Ann Armstrong, Fresno, CA (US); Michael Franz, Fresno, CA (US)

(21) Appl. No.: 14/798,105

(22) Filed: Jul. 13, 2015

Related U.S. Application Data
(60) Provisional application No. 62/024,281, filed on Jul. 14, 2014.

(51) Int. Cl. B65D 5/44; B31B 7/00; B65D 5/22; B65D 5/42; B65D 5/00

(52) U.S. Cl. CPC B65D 5/443; B65D 5/4266; B65D 5/0015; B65D 5/22; B31B 7/00

(57) ABSTRACT

A blank of sheet material for forming a container includes a bottom panel and two opposing side panels. Each side panel extends from a side edge of the bottom panel. The blank also includes two opposing end panel assemblies. Each end panel assembly extends from an end edge of the bottom panel and includes an outer end panel extending from the end edge, and an inner end panel extending from a top edge of the outer end panel. The blank further includes a plurality of reinforcing side panel assemblies. Each reinforcing side panel assembly extends from a side edge of one of the end panel assemblies. Each reinforcing side panel assembly includes a first reinforcing side panel extending from the inner end panel, and a second reinforcing side panel extending from the first reinforcing side panel and the outer end panel.

### CROSS REFERENCE TO RELATED APPLICATIONS

This application claims the benefit of U.S. Provisional Application No. 62/024,281, filed Jul. 14, 2014, the disclosure of which is hereby incorporated in its entirety.

### BACKGROUND

The field of the present disclosure relates generally to a blank for forming a container and, more particularly, to a blank fabricated from a corrugated paperboard material for forming a container having multiple stacking tabs and reinforced side walls.

Containers are frequently utilized to store and aid in transporting products. These containers can be square, hexagonal, or octagonal. Some of these containers are referred to as shipping trays because they are used to ship or transport products for eventual sale. In at least some known cases, a blank of sheet material is used to form a container or tray for transporting a product. Such containers may have certain strength requirements for transporting products. These strength requirements may include a stacking strength requirement such that the containers can be stacked on one another during transport without collapsing. In some cases, bliss-type containers are used to satisfy such stacking strength requirements. For example, fruit and produce from certain regions are sometimes packaged in bliss-type corrugated containers. Bliss ends of the bliss-type corrugated container are generally laminated in a secondary manufacturing process or outsourced to a third party for laminating. Laminating the bliss ends facilitates ensuring the container has sufficient stack strength capabilities. However, such lamination may be a costly and time-consuming process.

### BRIEF DESCRIPTION

In one aspect, a blank of sheet material for forming a container is provided. The blank includes a bottom panel and two opposing side panels. Each side panel extends from a side edge of the bottom panel. The blank also includes two opposing end panel assemblies. Each end panel assembly extends from an end edge of the bottom panel and includes an outer end panel extending from the end edge, and an inner end panel extending from a top edge of the outer end panel. The blank further includes a plurality of reinforcing side panel assemblies. Each reinforcing side panel assembly extends from a side edge of one of the end panel assemblies. Each reinforcing side panel assembly includes a first reinforcing side panel extending from the inner end panel of the respective end panel assembly, and a second reinforcing side panel extending from the first reinforcing side panel and the outer end panel of the respective end panel assembly.

In another aspect, a container formed from a blank of sheet material is provided. The container includes a bottom wall and two opposing end walls. Each end wall includes an outer end panel emanating from an end edge of the bottom wall, and an inner end panel emanating from a top edge of the outer end panel. The inner end panel is coupled to the outer end panel in substantially face-to-face relationship. The container also includes two opposing side walls. A first of the side walls includes a side panel emanating from a side edge of the bottom panel, a first reinforcing side panel emanating from a side edge of the inner end panel of a first of the end walls, and a second reinforcing side panel emanating from the first reinforcing side panel and the outer end panel of the first end wall. The second reinforcing side panel is coupled between the first reinforcing side panel and the side panel.

In another aspect, a method for forming a container from a blank of sheet material is provided. The blank includes a bottom panel, two opposing side panels each extending from a side edge of the bottom panel, two opposing end panel assemblies each extending from an end edge of the bottom panel, and a plurality of reinforcing side panel assemblies. The reinforcing side panel assemblies each extend from a side edge of one of the end panel assemblies. Each end panel assembly includes an outer end panel extending from the end edge, and an inner end panel extending from a top edge of the outer end panel. Each reinforcing side panel assembly includes a first reinforcing side panel extending from the inner end panel, and a second reinforcing side panel extending from the first reinforcing side panel and the outer end panel of the respective end panel assembly. The method includes rotating inwardly each end panel assembly such that each end panel assembly is substantially perpendicular to the bottom panel. The method also includes rotating inwardly each inner end panel into substantially face-to-face relationship with the outer end panel of the respective end panel assembly. The method further includes rotating each reinforcing side panel assembly to extend substantially along one of the side edges of the bottom panel, and coupling each of the side panels to two of the reinforcing side panel assemblies to form the container.

### BRIEF DESCRIPTION OF THE DRAWINGS

FIG. 1 is a top plan view of an example blank of sheet material for forming a container in accordance with the present disclosure.

FIG. 2 is a perspective view of an example container formed from the blank shown in FIG. 1 including top panels in an open position.

FIG. 3 is a top plan view of an example blank of sheet material for forming a container in accordance with a first alternative embodiment of the present disclosure.

FIG. 4 is a perspective view of an example container formed from the blank shown in FIG. 3 including an elongated cutout relief opening.

FIG. 5 is a top plan view of an example blank of sheet material for forming a container in accordance with a second alternative embodiment of the present disclosure.

FIG. 6 is a perspective view of an example container formed from the blank shown in FIG. 5 including securing flaps.

FIG. 7 is a top plan view of an example blank of sheet material for forming a container in accordance with a third alternative embodiment of the present disclosure.

FIG. 8 is a perspective view of an example container formed from the blank shown in FIG. 7 having an open top configuration.

FIG. 9 is a top plan view of an example blank of sheet material for forming a container in accordance with a fourth alternative embodiment of the present disclosure.

FIG. 10 is a perspective view of an example container formed from the blank shown in FIG. 9 having an open top configuration and a product removal slot.

FIG. 11 is a top plan view of an example blank of sheet material for forming a container in accordance with a fifth alternative embodiment of the present disclosure.

FIG. 12 is a perspective view of an example container formed from the blank shown in FIG. 11 having an open top configuration and a product removal slot.

FIG. 13 is a top plan view of an example blank of sheet material for forming a container in accordance with a sixth alternative embodiment of the present disclosure.

FIG. 14 is a perspective view of an example container formed from the blank shown in FIG. 13 having an open top configuration and rollover panels.

### DETAILED DESCRIPTION

The following detailed description illustrates the disclosure by way of example and not by way of limitation. The description clearly enables one skilled in the art to make and use the disclosure, describes several embodiments, adaptations, variations, alternatives, and use of the disclosure, including what is presently believed to be the best mode of carrying out the disclosure.

Embodiments of the present disclosure provide a stackable container including stacking tabs and internal support structures. The container is constructed from a blank of sheet material using a machine and/or by hand. For example, the blank can be wrapped about a mandrel to form a container, or the container can be formed by hand and/or by another style of a tray forming machine. Alternatively, a folder/glue machine can be used to convey the blank through folder arms and an adhesive applicator to form the container. In another embodiment, the container is formed into a knock-down flat container, and final construction is performed by hand. In one embodiment, the container is fabricated from a corrugated paperboard material having a plurality of flutes. The container, however, may be fabricated using any suitable material, and therefore is not limited to a specific type of material. In alternative embodiments, the container is fabricated using cardboard, plastic, fiberboard, paperboard, foamboard, corrugated paper, and/or any suitable material known to those skilled in the art and guided by the teachings herein provided.

In an example embodiment, the container includes at least one marking thereon including, without limitation, indicia that communicates the product, a manufacturer of the product and/or a seller of the product. For example, the marking may include printed text that indicates a product's name and briefly describes the product, logos and/or trademarks that indicate a manufacturer and/or seller of the product, and/or designs and/or ornamentation that attract attention. “Printing,” “printed,” and/or any other form of “print” as used herein may include, but is not limited to including, ink jet printing, laser printing, screen printing, giclee, pen and ink, painting, offset lithography, flexography, relief print, rotogravure, dye transfer, and/or any suitable printing technique known to those skilled in the art and guided by the teachings herein provided. In another embodiment, the container is void of markings, such as, without limitation, indicia that communicates the product, a manufacturer of the product and/or a seller of the product.

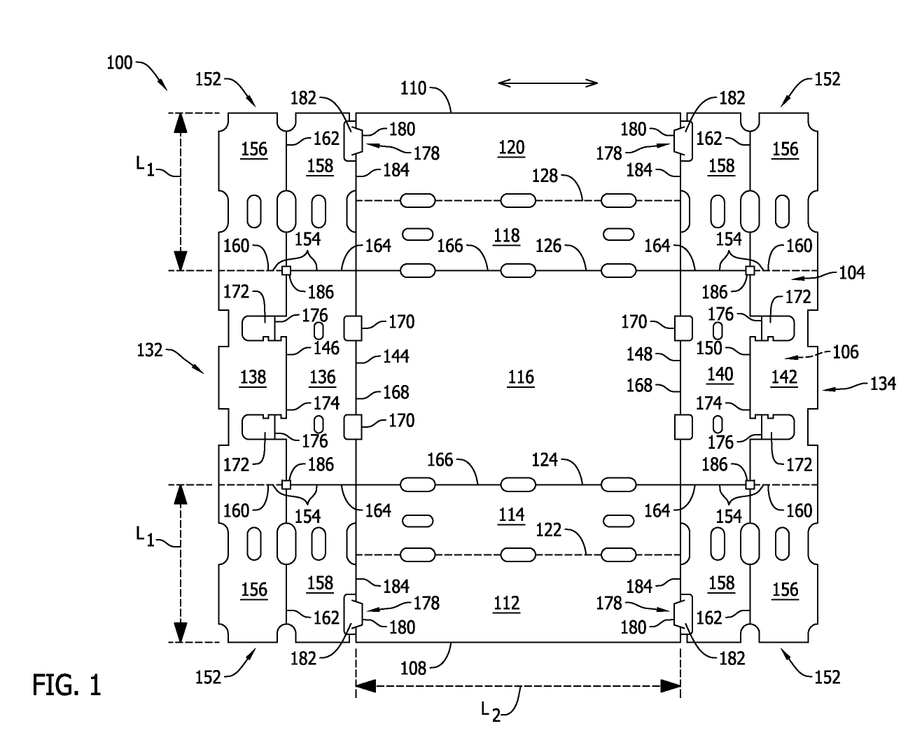

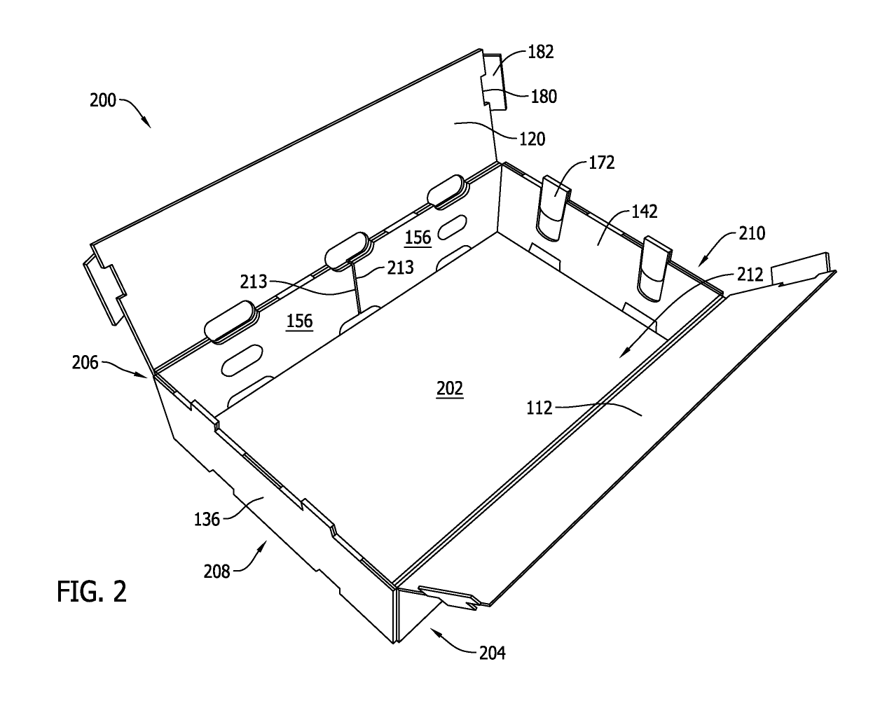

Referring now to the drawings, FIG. 1 is a top plan view of an example blank 100 of sheet material for forming a container 200 (shown in FIG. 2). Blank 100 includes a first or interior surface 104 and an opposing second or exterior surface 106. Blank 100 defines a first edge 108 and an opposing second edge 110. In one embodiment, blank 100 includes, in series from first edge 108 to second edge 110, a first top panel 112, a first side panel 114, a bottom panel 116, a second side panel 118, and a second top panel 120. First top panel 112 is coupled to first side panel 114 along a first perforation line 122, first side panel 114 is coupled to bottom panel 116 along a first fold line 124, bottom panel 116 is coupled to second side panel 118 along a second fold line 126, and second side panel 118 is coupled to second top panel 120 along a second perforation line 128.

Blank 100 also includes a first end panel assembly 132 coupled to bottom panel 116, and a second end panel assembly 134 coupled to bottom panel 116. First end panel assembly 132 includes a first outer end panel 136 and a first inner end panel 138, and second end panel assembly 134 includes a second outer end panel 140 and a second inner end panel 142. First outer end panel 136 is coupled to bottom panel 116 along a third fold line 144, first inner end panel 138 is coupled to first outer end panel 136 along a first score line 146, second outer end panel 140 is coupled to bottom panel 116 along a fourth fold line 148, and second inner end panel 142 is coupled to second outer end panel 140 along a second score line 150.

Blank 100 includes a plurality of reinforcing side panel assemblies 152 coupled to and extending from a side edge 154 of each end panel assembly 132 and 134. Each reinforcing side panel assembly 152 includes a first reinforcing side panel 156 and a second reinforcing side panel 158. First reinforcing side panels 156 are coupled to and extend from inner end panels 138 and 142, respectively, and second reinforcing side panels 158 extend between first reinforcing side panels 156 and respective outer end panels 136 and 140. Specifically, first reinforcing side panel 156 is coupled to the respective one of inner end panels 138 and 142 along a third perforation line 160, and is coupled to second reinforcing side panel 158 along a third score line 162. Moreover, second reinforcing side panel 158 is coupled to and extends from respective outer end panels 136 and 140 along a fifth fold line 164.

By connecting panel 156 to panels 138 and 142, the overall strength of container 200 is increased. Specifically, the stacking strength and strength of container 200 to resist side loads is increased. Thus, the use of third perforation line 160 between panel 156 and panels 138 and 142, as compared to a cut line extending through a thickness of blank 100, increases the overall strength of container 200. Moreover, as will be described in more detail below, the use of third perforation line 160 also facilitates machine forming container 200 by reducing the number of contact points needed to fold reinforcing side panel assemblies 152.

First and second reinforcing side panels 156 and 158 each have a length L₁ that is about one-half a length L₂ of side panels 114 and 120. Length L₁ of first and second reinforcing side panels 156 and 158 ensures a double wall thickness along substantially the entire length L₂ of side panels 114 and 118 when container 200 is formed. As such, the stacking strength of container 200 is increased. Moreover, extending reinforcing side panel assemblies 152 along side panels 114 and 118 forms a first portion (not shown) of a side wall of container 200 that can bear a greater load when compared to a second portion (not shown) of the side wall formed from side panels 114 and 118. By relieving side panels 114 and 118 of substantial load-bearing responsibilities, exterior surfaces 106 of side panels 114 and 118 can be used to display identifying information and/or decorative designs, for example. Moreover, relieving side panels 114 and 118 of significant load-bearing responsibilities ensures information or designs displayed on exterior surfaces 106 of side panels 114 and 118 remain substantially unaltered in an event such as compression of reinforcing side panel assemblies 152.

Bottom panel 116 defines side edges 166 along first and second fold lines 124 and 126, and defines end edges 168 along third and fourth fold lines 144 and 148. Side panels 114 and 118 extend from side edges 166 of bottom panel 116, and end panel assemblies 132 and 134 extend from end edges 168 of bottom panel.

In the example embodiment, a pair of stacking tab slots 170 is defined along fold lines 144 and 148. Slots 170 are configured to receive a stacking tab from a lower container when multiple containers 200 are stacked on top of each other. Specifically, each end panel assembly 132 and 134 includes at least one stacking tab 172 defined therein. Stacking tab 172 extends from a top edge 174 of outer end panels 136 and 140, and is defined along a sixth fold line 176. Stacking tabs 172 are sized for insertion in slots 170 of a formed container 200 when in a stacked configuration.

Moreover, stacking tabs 172 are configured to be inserted within in a locking mechanism 178 attached to top panels 112 and 120 such that top panels 112 and 120 can be locked in a closed position when stacking tabs 172 are inserted within locking mechanism 178. More specifically, locking mechanism 178 includes a locking slot 180 sized to receive stacking tabs 172, and a closure flap 182 extending from side edges 184 of top panels 112 and 120. As such, locking slots 180 selectively engage stacking tabs 172 as top panels 112 and 120 are operable between open and closed positions.

Blank 100 further includes a cutout relief opening 186 defined at an interface between outer and inner end panels 136 and 140, and 138 and 142, respectively, and between first and second reinforcing side panels 156 and 158. While shown as having a substantially square cross-sectional shape, as will be described in more detail below, cutout relief opening 186 may have any shape that enables blank 100 to function as described herein. Cutout relief opening 186 removes material from blank 100 such that container 200 can be formed more easily as the panels are folded over each other.

As described above, blank 100 may be fabricated from any material that enables container 200 to function as described herein. If a corrugated paperboard material is implemented, a direction of corrugation flutes extending along blank 100 is indicated by the double-headed arrow shown in FIG. 1. Although certain lines of weakness (e.g., fold lines, perforation lines, score lines, and cut lines) are shown herein, it should be understood that other lines of weakness can be used and still remain within the scope of the disclosure. The lines of weakness shown herein are not intended to be limiting, but rather are examples in nature.

FIG. 2 is a perspective view of container 200 formed from blank 100 (shown in FIG. 1). In the example embodiment, container 200 includes a bottom wall 202, first and second opposing side walls 204 and 206, and first and second opposing end walls 208 and 210. Each of walls 202, 204, 206, 208, and 210 define a cavity 212 within container 200. Moreover, as will be described in more detail below, end panel assemblies 132 and 134 and reinforcing side panel assemblies 152 cooperate to define at least a double wall thickness for each of walls 204, 206, 208, and 210 around a perimeter of container 200 when formed. As described above, the corrugation flutes extend in a direction indicated by the double-headed arrow shown in FIG. 1 such that the corrugation flutes are oriented substantially vertically in the double-thick portions of walls 204, 206, 208, and 210 formed by end panel assemblies 132 and 134 and reinforcing side panel assemblies 152 when container 200 is formed.

Container 200 is formed by folding blank 100 along fold lines, perforation lines, and/or score lines. Specifically, first end wall 208 is formed by rotating end panel assembly 132 about score line 146 towards interior surface 104 such that inner end panel 138 is coupled to outer end panel 136 in substantially face-to-face relationship, and such that first reinforcing side panels 156 are coupled to second reinforcing side panels 158 in substantially face-to-face relationship. As described above, perforation line 160 extends between inner end panel 138 and first reinforcing side panel 156 and facilitates machine forming container 200. More specifically, perforation line 160 ensures first reinforcing side panels 156 extending from opposing sides of inner end panel 138 remain connected thereto as end panel assembly 132 is rotated about score line 146. As such, first reinforcing side panels 156 are folded over second reinforcing side panels 158 and inner end panel 138 is folded over outer end panel 136 substantially simultaneously, thus reducing the number of steps when forming container 200. End panel assembly 132 is then rotated about fold line 144 towards interior surface 104. Second end wall 210 is formed in a substantially similar fashion.

After end walls 208 and 210 are formed, folded reinforcing side panel assemblies 152 are rotated to at least partially form side walls 204 and 206. Specifically, first side wall 204 of container 200 is formed by rotating a reinforcing side panel assembly 152 that extends from each end panel assembly 132 and 134 on a first side of blank 100. Each reinforcing side panel assembly 152 is rotated about now substantially overlapping perforation line 160 and fold line 164 such that reinforcing side panel assemblies 152 extend along a side edge 166 of bottom panel 116. First side panel 114 is then rotated about fold line 124 towards interior surface 104 to couple to reinforcing side panel assemblies 152. Specifically, first side panel 114 couples to exterior surface 106 of second reinforcing side panels 158 such that second reinforcing side panels 158 are coupled between first reinforcing side panels 156 and first side panel 114. For example, first side panel 114 is affixed to second reinforcing side panels 158 in any suitable fashion. As described above, length L₁ of reinforcing side panels 156 and 158 is about one-half a length L₂ of side panels 114 and 120. As such, end edges 213 of reinforcing side panel assemblies 152 are positioned adjacent to each other such that the corresponding reinforcing double wall thickness extends along substantially an entirety of side edge 166 of first side panel 114. Second side wall 206 is formed in a substantially similar fashion.

As described above, top panels 112 and 120 are selectively operable between open and closed positions. When in the closed position, top panels 112 and 120 are rotated about perforation lines 122 and 128 towards interior surface 104 such that locking slots 180 engage stacking tabs 172 with an interference fit. Closure flaps 182 are then rotated towards exterior surface 106 of outer end panels 136 and 140 to form container 200. For example, closure flaps 182 are affixed to outer end panels 136 and 140 in any suitable fashion.

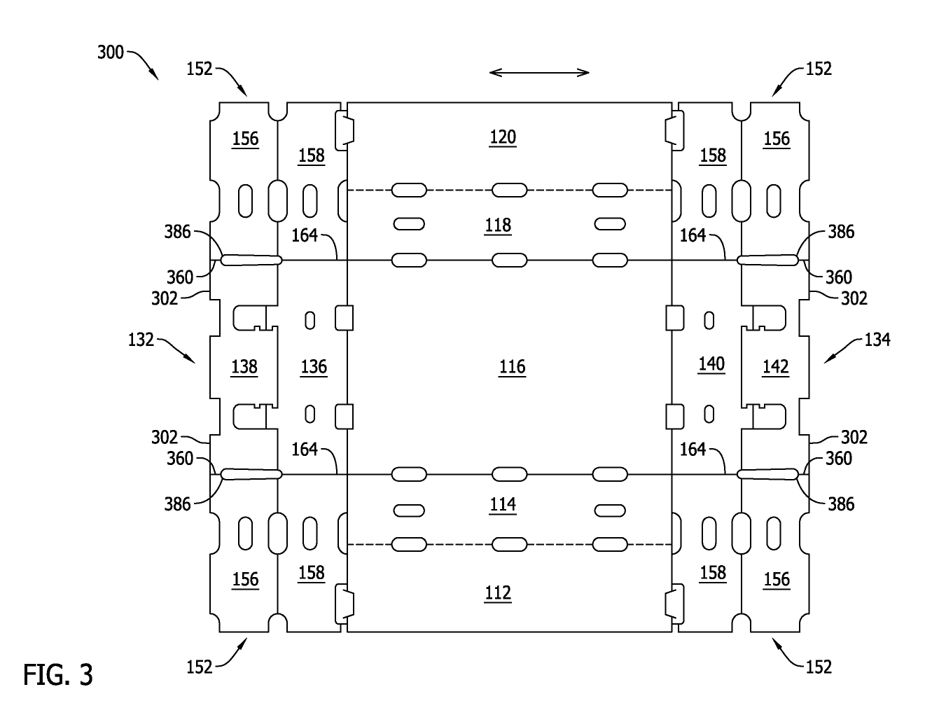

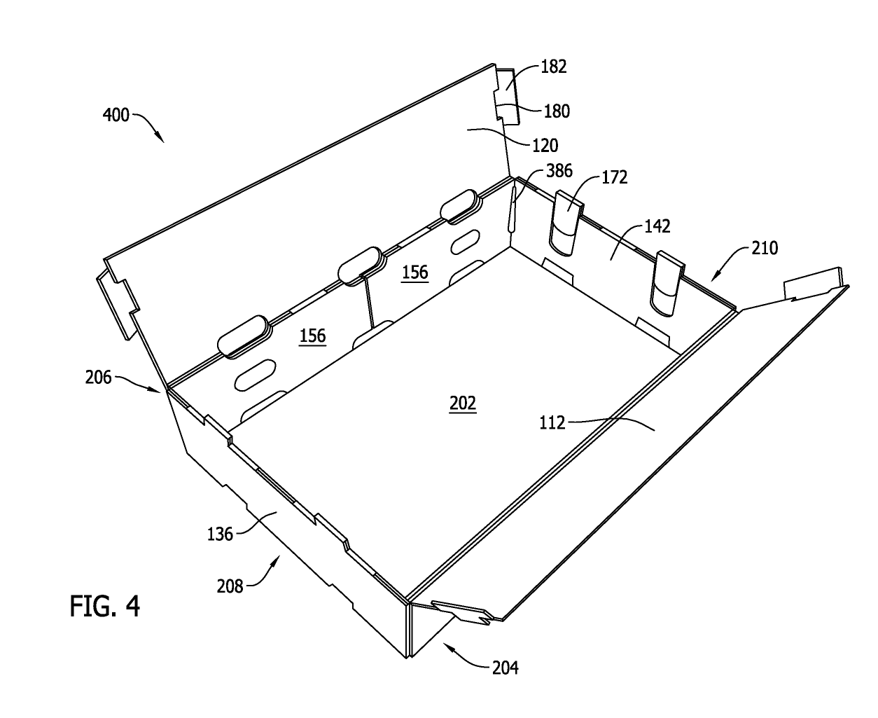

FIG. 3 is a top plan view of an example blank 300 of sheet material for forming a container 400 (shown in FIG. 4), and FIG. 4 is a perspective view of container 400. In the example embodiment, blank 300 includes an elongated cutout relief opening 386 defined at an interface between outer and inner end panels 136 and 140, and 138 and 142, respectively, and between first and second reinforcing side panels 156 and 158. Elongated cutout relief opening 386 extends from the interface along a fold line 360 towards an outer edge 302 of each end panel assembly 132 and 134. Elongated cutout relief opening 386 removes material from blank 300 such that container 400 can be formed more easily as reinforcing side panel assemblies are rotated about substantially overlapping fold lines 164 and 360. Moreover, elongated cutout relief opening 386 removes more material from blank 300 than cutout relief opening 186 from blank 100 such that fold line 360 extends between outer edge 302 and elongated cutout relief opening 386. Fold line 360 ensures first reinforcing side panels 156 remain coupled to respective inner end panels 138 and 142 during formation of container 400.

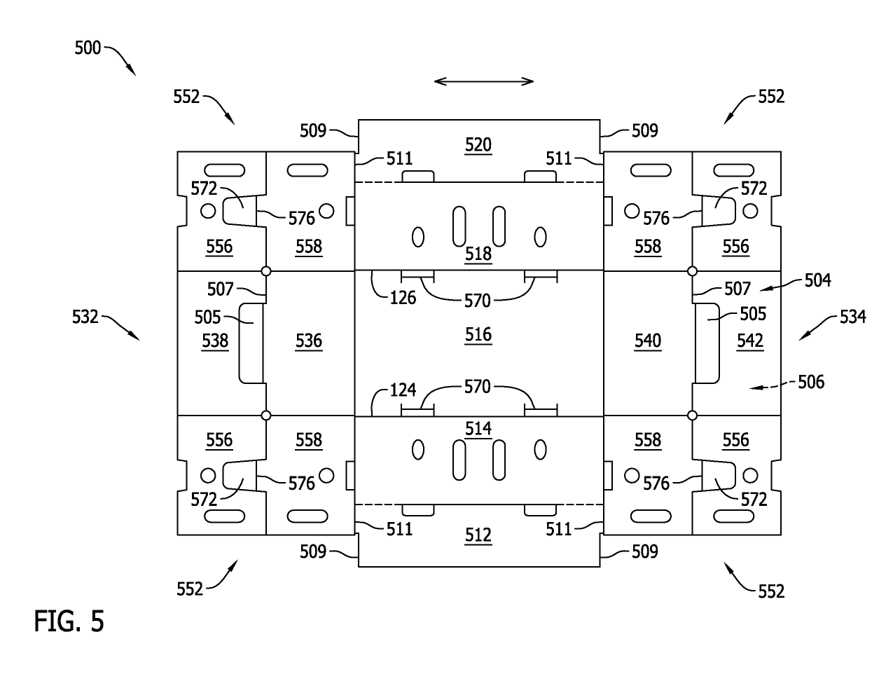

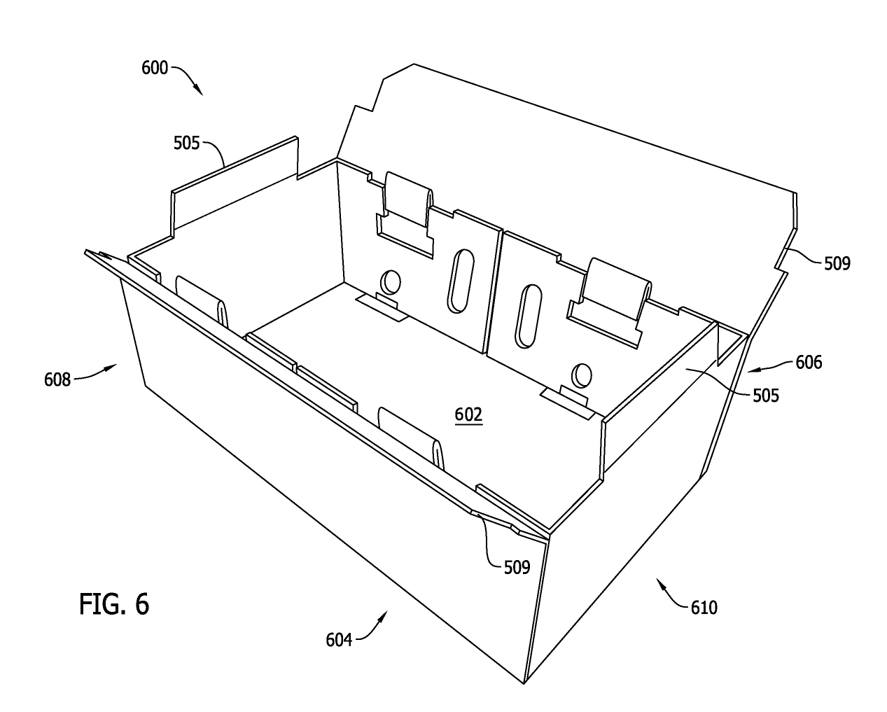

FIG. 5 is a top plan view of an example blank 500 of sheet material for forming a container 600 (shown in FIG. 6), and FIG. 6 is a perspective view of container 600. Blank 500 includes a first or interior surface 504 and an opposing second or exterior surface 506. Blank 500 includes a first top panel 512, a first side panel 514, a bottom panel 516, a second side panel 518, and a second top panel 520. Blank 500 also includes a first end panel assembly 532 coupled to bottom panel 516, and a second end panel assembly 534 coupled to bottom panel 516. First end panel assembly 532 includes a first outer end panel 536 and a first inner end panel 538, and second end panel assembly 534 includes a second outer end panel 540 and a second inner end panel 542. Blank 500 further includes a plurality of reinforcing side panel assemblies 552 coupled to and extending from each end panel assembly 532 and 534. Each reinforcing side panel assembly 552 includes a first reinforcing side panel 556 and a second reinforcing side panel 558.

In the example embodiment, a pair of stacking tab slots 570 is defined along fold lines 124 and 126. Slots 570 are configured to receive a stacking tab from a lower container when multiple containers 600 are stacked on top of each other. Specifically, each reinforcing side panel assembly 552 includes at least one stacking tab 572 defined therein. Stacking tab 572 extends from a fold line 576 defined along a top edge of second reinforcing side panel 558. Stacking tabs 572 are sized for insertion in slots 570 of a formed container 600 when in a stacked configuration.

Blank 500 further includes a securing mechanism that ensures top panels 512 and 520 can remain in a closed position. The securing mechanism includes a securing flap 505 extending from a top edge 507 of outer end panels 536 and 540, and securing cutouts 509 defined in opposing side edges 511 of top panels 512 and 520. As will be described in more detail below, when container 600 is formed and top panels 512 and 520 are in a closed position, securing flap 505 is sized to extend over securing cutouts 509 and couple to exterior surfaces 506 of top panels 512 and 520.

Referring to FIG. 6, container 600 includes a bottom wall 602, first and second opposing side walls 604 and 606, and first and second opposing end walls 608 and 610. Container 600 is formed by folding blank 500 along respective fold lines, perforation lines, and/or score lines. After bottom wall 602, first and second opposing side walls 604 and 606, and first and second opposing end walls 608 and 610 have been formed, top panels 512 and 520 are rotated towards interior surface 504 such that securing cutouts 509 from first top panel 512 are substantially aligned with securing cutouts 509 from second top panel 520. Securing flaps 505 are then rotated towards exterior surfaces 506 of top panels 512 and 520 to couple thereto.

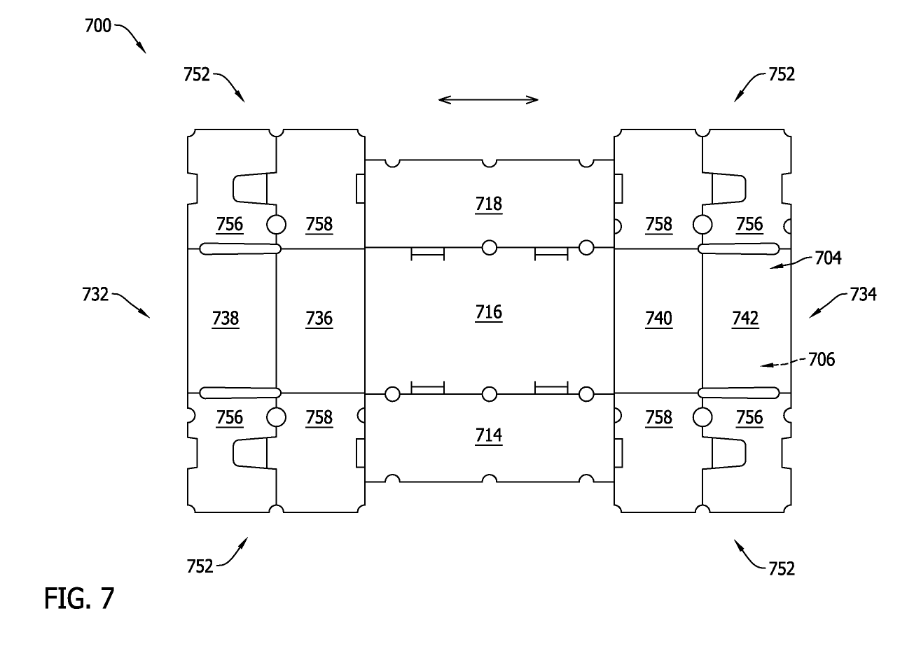

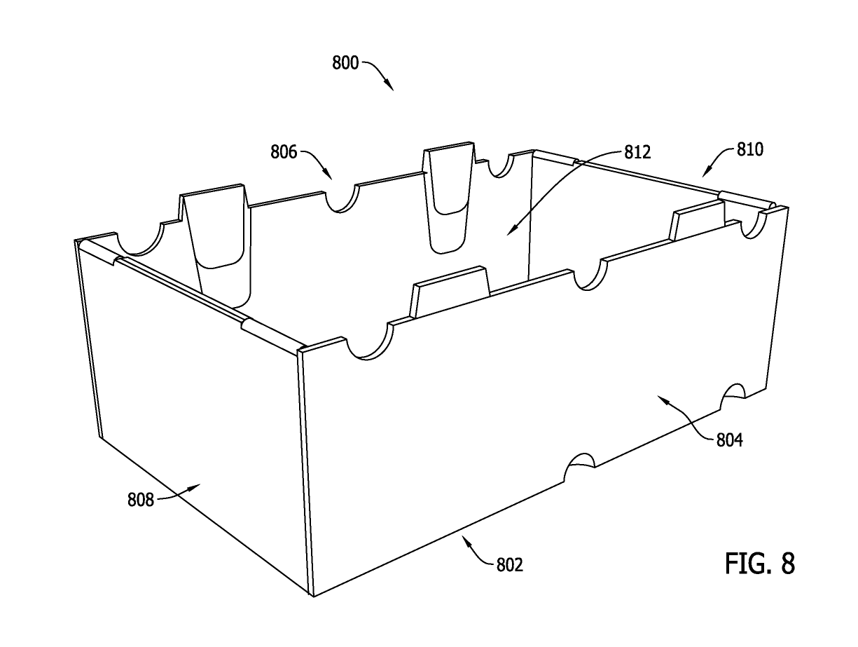

FIG. 7 is a top plan view of an example blank 700 of sheet material for forming a container 800 (shown in FIG. 8), and FIG. 8 is a perspective view of container 800. Blank 700 includes a first or interior surface 704 and an opposing second or exterior surface 706. Blank 700 includes a first side panel 714, a bottom panel 716, and a second side panel 718. Blank 700 also includes a first end panel assembly 732 coupled to bottom panel 716, and a second end panel assembly 734 coupled to bottom panel 716. First end panel assembly 732 includes a first outer end panel 736 and a first inner end panel 738, and second end panel assembly 734 includes a second outer end panel 740 and a second inner end panel 742. Blank 700 further includes a plurality of reinforcing side panel assemblies 752 coupled to and extending from each end panel assembly 732 and 734. Each reinforcing side panel assembly 752 includes a first reinforcing side panel 756 and a second reinforcing side panel 758.

Referring to FIG. 8, container 800 includes a bottom wall 802, first and second opposing side walls 804 and 806, and first and second opposing end walls 808 and 810. Container 800 is formed by folding blank 700 along respective fold lines, perforation lines, and/or score lines. Container 800 also includes an internal cavity 812 defined by walls 802-810. Because container 800 does not include top panels, internal cavity 812 is exposed to an ambient environment.

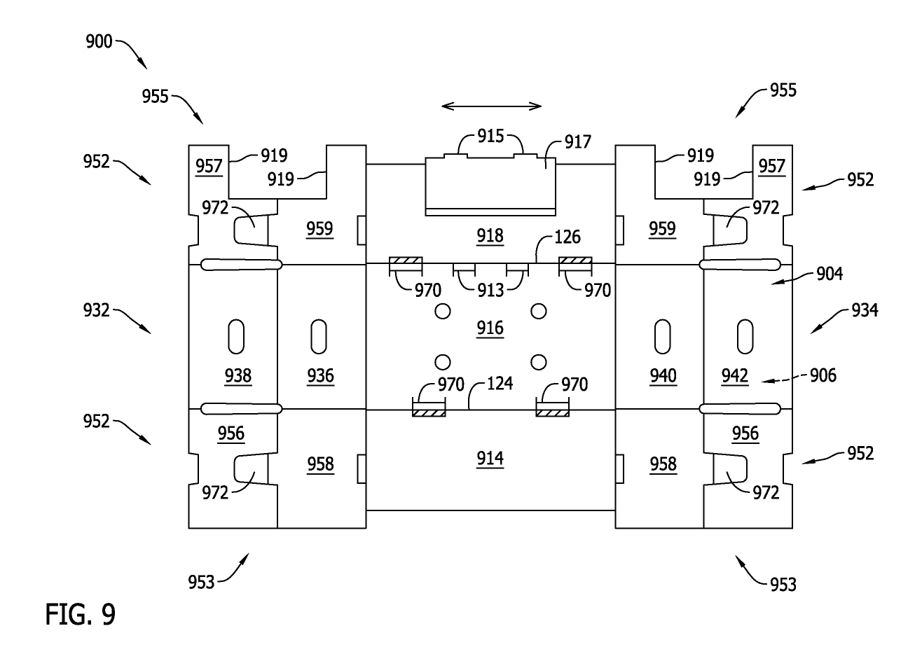

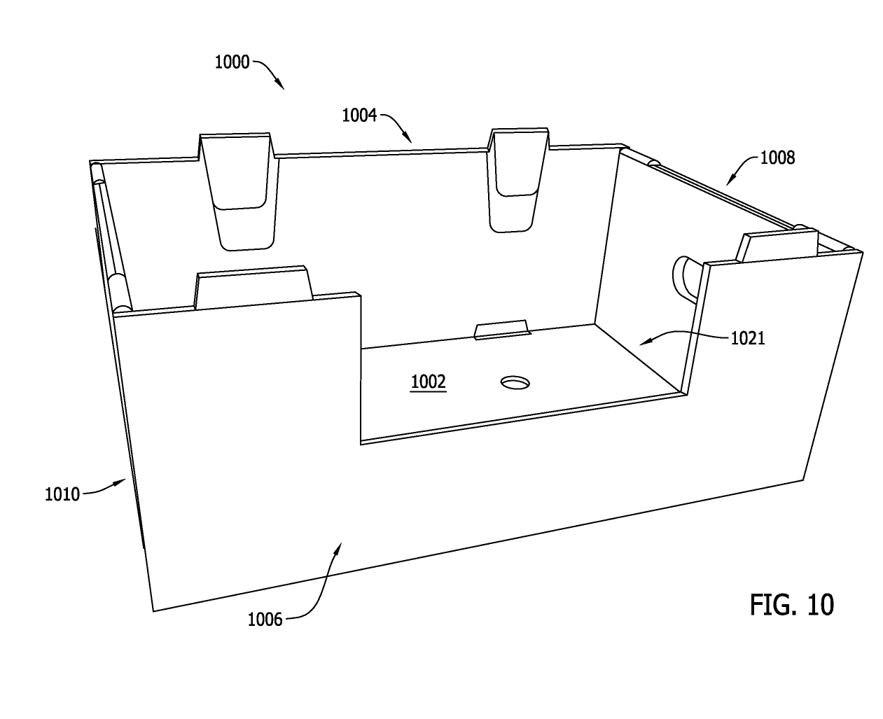

FIG. 9 is a top plan view of an example blank 900 of sheet material for forming a container 1000 (shown in FIG. 10), and FIG. 10 is a perspective view of container 1000. Blank 900 includes a first or interior surface 904 and an opposing second or exterior surface 906. Blank 900 includes a first side panel 914, a bottom panel 916, and a second side panel 918. Blank 900 also includes a first end panel assembly 932 coupled to bottom panel 916, and a second end panel assembly 934 coupled to bottom panel 916. First end panel assembly 932 includes a first outer end panel 936 and a first inner end panel 938, and second end panel assembly 934 includes a second outer end panel 940 and a second inner end panel 942.

Moreover, a pair of window panel slots 913 is defined along fold line 126. Slots 913 are configured to receive a holding tab 915 extending from a window panel 917 defined in second side panel 918. Specifically, as will be described in more detail below, holding tabs 915 are sized for insertion within slots 913 such that window panel 917 remains coupled to bottom panel 916 forming a product removal slot (not shown in FIG. 9) in container 1000.

Blank 900 further includes a plurality of reinforcing side panel assemblies 952 including a first reinforcing side panel assembly 953 and a second reinforcing side panel assembly 955. Specifically, each end panel assembly 932 and 934 includes one first reinforcing side panel assembly 953 and one second reinforcing side panel assembly 955 extending from opposing sides thereof. First reinforcing side panel assembly 953 includes a first reinforcing side panel 956 and a second reinforcing side panel 958, and second reinforcing side panel assembly 955 includes a third reinforcing side panel 957 and a fourth reinforcing side panel 959. Each of reinforcing side panels 957 and 959 include complementary slot cutouts 919 defined therein. As will be described in more detail below, a shape of slot cutouts 919 is selected to ensure the product removal slot is substantially unobstructed when container 1000 is formed.

In the example embodiment, a pair of stacking tab slots 970 is defined along fold lines 124 and 126. Slots 970 are configured to receive a stacking tab from a lower container when multiple containers 1000 are stacked on top of each other. Specifically, each reinforcing side panel assembly 952 includes at least one stacking tab 972 defined therein. Stacking tabs 972 are sized for insertion in slots 970 of a formed container 1000 when in a stacked configuration.

Referring to FIG. 10, container 1000 includes a bottom wall 1002, first and second opposing side walls 1004 and 1006, and first and second opposing end walls 1008 and 1010. Container 1000 is formed by folding blank 900 along respective fold lines, perforation lines, and/or score lines. Specifically, second side wall 1006 is formed by rotating end panel assemblies 932 and 934 towards interior surface 904 such that inner end panels 938 and 942 are coupled to respective outer end panels 936 and 940, and such that third reinforcing side panels 957 are coupled to fourth reinforcing side panels 959. End panel assemblies 932 and 934 are then rotated towards interior surface 904, and second side panel 918 is rotated towards interior surface 904 such that fourth reinforcing side panels 959 are coupled between third reinforcing side panels 957 and second side panel 918. For example, second side panel 918 is affixed to fourth reinforcing side panels 959 in any suitable fashion.

A product removal slot 1021 is formed in second side wall 1006 by rotating window panel 917 towards interior surface 904 such that at least a portion of second reinforcing side panel assemblies 955 are positioned between window panel 917 and second side panel 918. Moreover, holding tabs 915 are inserted within window panel slots 913 such that window panel 917 remains coupled to bottom panel 916.

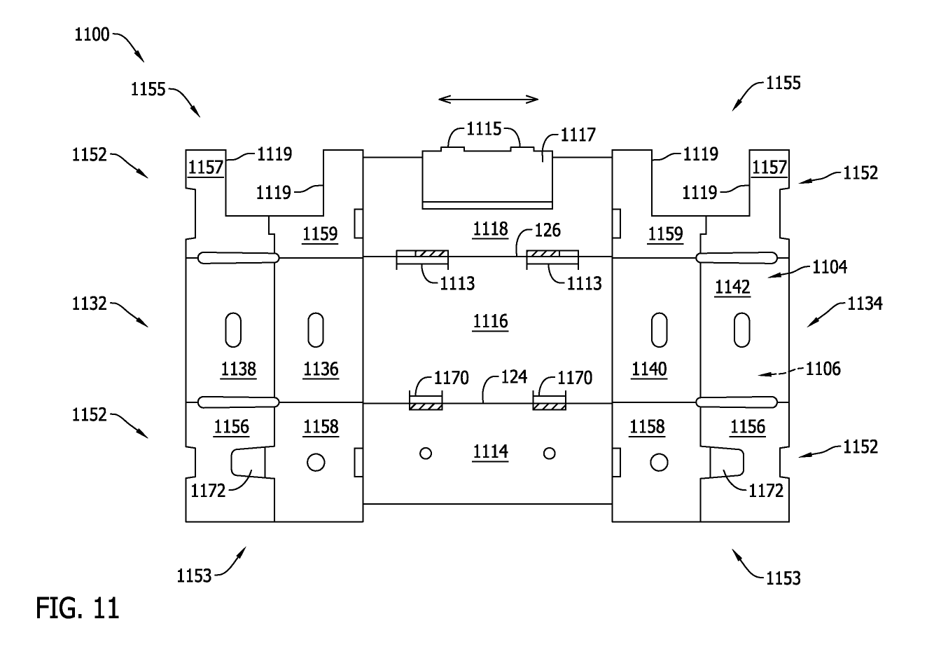

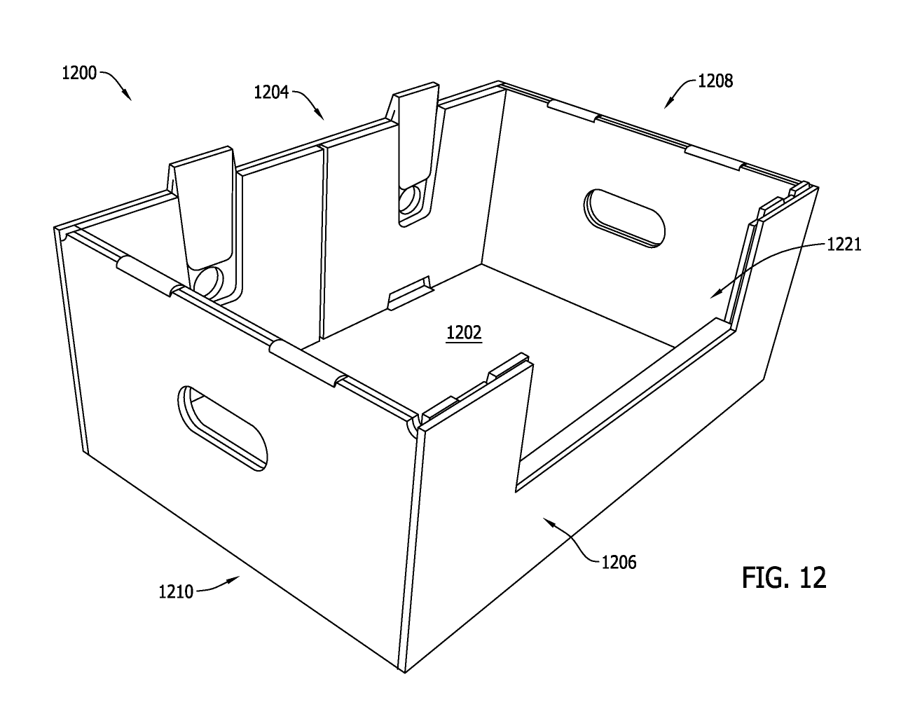

FIG. 11 is a top plan view of an example blank 1100 of sheet material for forming a container 1200 (shown in FIG. 12), and FIG. 12 is a perspective view of container 1200. Blank 1100 includes a first or interior surface 1104 and an opposing second or exterior surface 1106. Blank 1100 includes a first side panel 1114, a bottom panel 1116, and a second side panel 1118. Blank 1100 also includes a first end panel assembly 1132 coupled to bottom panel 1116, and a second end panel assembly 1134 coupled to bottom panel 1116. First end panel assembly 1132 includes a first outer end panel 1136 and a first inner end panel 1138, and second end panel assembly 1134 includes a second outer end panel 1140 and a second inner end panel 1142.

Moreover, a pair of window panel slots 1113 is defined along fold line 126. Slots 1113 are configured to receive a holding tab 1115 extending from a window panel 1117 defined in second side panel 1118. Specifically, as will be described in more detail below, holding tabs 1115 are sized for insertion within slots 1113 such that window panel 1117 remains coupled to bottom panel 1116 forming a product removal slot (not shown in FIG. 9) in container 1200.

Blank 1100 further includes a plurality of reinforcing side panel assemblies 1152 including a first reinforcing side panel assembly 1153 and a second reinforcing side panel assembly 1155. Specifically, each end panel assembly 1132 and 1134 includes one first reinforcing side panel assembly 1153 and one second reinforcing side panel assembly 1155 extending from opposing sides thereof. First reinforcing side panel assembly 1153 includes a first reinforcing side panel 1156 and a second reinforcing side panel 1158, and second reinforcing side panel assembly includes a third reinforcing side panel 1157 and a fourth reinforcing side panel 1159. Each of reinforcing side panels 1157 and 1159 include complementary slot cutouts 1119 defined therein. As will be described in more detail below, a shape of slot cutouts 1119 is selected to ensure the product removal slot is substantially unobstructed when container 1200 is formed.

In the example embodiment, a pair of stacking tab slots 1170 is defined along fold line 124. Slots 1170 are configured to receive a stacking tab from a lower container when multiple containers 1200 are stacked on top of each other. Specifically, at least one reinforcing side panel assembly 1152 coupled to first or second end panel assemblies 1132 or 1134 include at least one stacking tab 1172 defined therein. Stacking tabs 1172 are sized for insertion in slots 1170 of a formed container 1200 when in a stacked configuration.

Referring to FIG. 12, container 1200 includes a bottom wall 1202, first and second opposing side walls 1204 and 1206, and first and second opposing end walls 1208 and 1210. Container 1200 is formed by folding blank 1100 along respective fold lines, perforation lines, and/or score lines. Specifically, second side wall 1206 is formed by rotating end panel assemblies 1132 and 1134 towards interior surface 1104 such that inner end panels 1138 and 1142 are coupled to respective outer end panels 1136 and 1140, and such that third reinforcing side panels 1157 are coupled to fourth reinforcing side panels 1159. End panel assemblies 1132 and 1134 are then rotated towards interior surface 1104, and second side panel 1118 is rotated towards interior surface 1104 such that fourth reinforcing side panels 1159 are coupled between third reinforcing side panels 1157 and second side panel 1118. For example, second side panel 1118 is affixed to fourth reinforcing side panels 1159 in any suitable fashion.

A product removal slot 1221 is formed in second side wall 1206 by rotating window panel 1117 towards interior surface 1104 such that at least a portion of second reinforcing side panel assemblies 1155 are positioned between window panel 1117 and second side panel 1118. Moreover, holding tabs 1115 are inserted within window panel slots 1113 such that window panel 1117 remains coupled to bottom panel 1116.

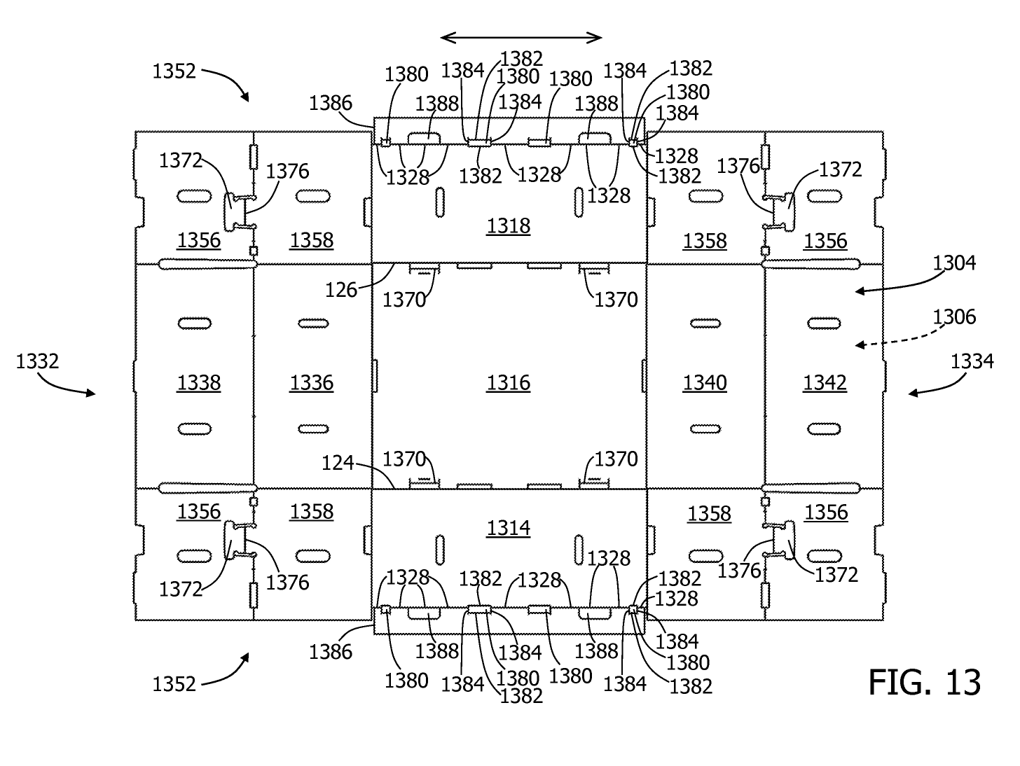

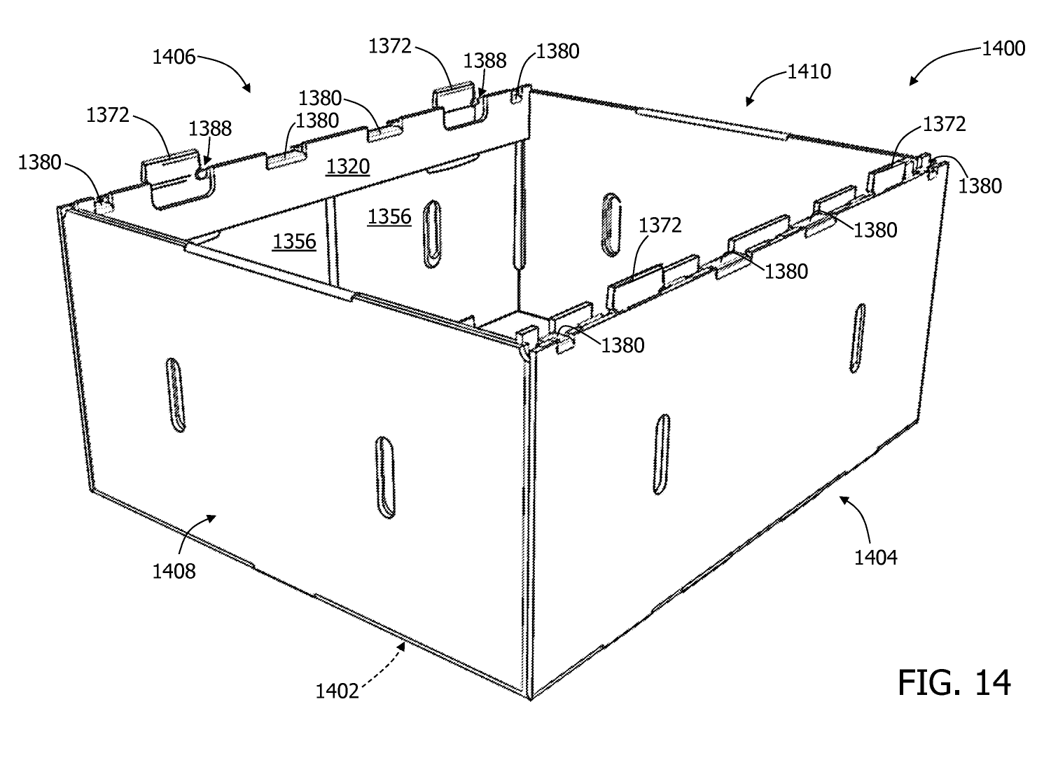

FIG. 13 is a top plan view of an example blank 1300 of sheet material for forming a container 1400 (shown in FIG. 14), and FIG. 14 is a perspective view of container 1400. Blank 1300 includes a first or interior surface 1304 and an opposing second or exterior surface 1306. Blank 1300 includes a first rollover panel 1312, a first side panel 1314, a bottom panel 1316, a second side panel 1318, and a second rollover panel 1320. Blank 1300 also includes a first end panel assembly 1332 coupled to bottom panel 1316, and an opposite second end panel assembly 1334 coupled to bottom panel 1316. First end panel assembly 1332 includes a first outer end panel 1336 and a first inner end panel 1338, and second end panel assembly 1334 includes a second outer end panel 1340 and a second inner end panel 1342. Blank 1300 further includes a plurality of reinforcing side panel assemblies 1352 coupled to and extending from opposing side edges of each end panel assembly 1332 and 1334. Each reinforcing side panel assembly 1352 includes a first reinforcing side panel 1356 and a second reinforcing side panel 1358.

In the example embodiment, a pair of stacking tab slots 1370 is defined along fold lines, 124 and 126. Slots 1370 are configured to receive a stacking tab from a lower container when multiple containers 1400 are stacked on top of each other. Specifically, each reinforcing side panel assembly 1352 includes at least one stacking tab 1372 defined therein. Stacking tab 1372 extends from a fold line 1376 defined along a top edge of second reinforcing side panel 1358. Stacking tabs 1372 are sized for insertion in slots 1370 of a formed container 1400 when in a stacked configuration.

A respective cut line 1328 is defined along a portion of a bottom edge of each of first rollover panel 1312 and second rollover panel 1320. Respective cut lines 1328 partially separate first rollover panel 1312 from first side panel 1314, and second rollover panel 1320 from second side panel 1318. However, a respective plurality of connector panels 1380 interrupts and spans across each cut line 1328 to couple first rollover panel 1312 to first side panel 1314, and to couple second rollover panel 1320 to second side panel 1318. Each connector panel 1380 is defined by a pair of fold lines 1382 defined substantially parallel to and offset from cut line 1328, and further by a pair of cut lines 1384 defined substantially perpendicular to cut line 1328. Connector panels 1380 enable first rollover panel 1312 and second rollover panel 1320 to be rotated about cut line 1328 into substantially face-to-face relationship with at least a portion of reinforcing side panel assemblies 1352 when container 1400 is formed, to facilitate securing reinforcing side panel assemblies 1352 against respective first and second side panels 1314 and 1318.

In the example embodiment, each plurality of connector panels 1380 includes four connector panels 1380. More specifically, each plurality of connector panels 1380 includes a pair of centrally positioned, elongated connector panels 1380 and a pair of shorter connector panels 1380 positioned near opposing side edges 1386 of respective first and second side panels 1314 and 1318. Alternatively, each plurality of connector panels 1380 includes any suitable number of connector panels 1380 each having any suitable shape and position that enables rollover panels 1312 and 1320 to function as described herein.

In the example embodiment, each of first rollover panel 1312 and second rollover panel 1320 includes at least one clearance slot 1388 defined at least partially by, and extending from, cut line 128. Each clearance slot 1388 is configured to align with a respective stacking tab 1372 and to receive the respective stacking tab 1372 therethrough when container 1400 is formed. Thus, clearance slots 1388 enable rollover panels 1312 and 1320 to clear stacking tabs 1372 as rollover panels 1312 and 1320 are rotated into substantially face-to-face relationship with at least a portion of reinforcing side panel assemblies 1352 when container 1400 is formed. In alternative embodiments, cut line 128 is further interrupted by secondary stacking tabs that extend from a top edge of respective first and second side panels 1314 and 1318 into rollover panels 1312 and 1320, and clearance slots 1388 are formed when rollover panels 1312 and 1320 are rotated towards reinforcing side panel assemblies 1352, such that the secondary stacking tabs are aligned with stacking tabs 1372. In other alternative embodiments, rollover panels 1312 and 1320 include punch-out tabs (not shown), rather than clearance slots 1388, to accommodate stacking tabs 1372. In still other alternative embodiments, blank 1300 does not include clearance slots 1388 and/or stacking tabs 1372.

Referring to FIG. 14, container 1400 includes a bottom wall 1402, first and second opposing side walls 1404 and 1406, and first and second opposing end walls 1408 and 1410. Container 1400 is formed by folding blank 1300 along respective fold lines, perforation lines, and/or score lines in a similar fashion as described above for forming container 200 from blank 100. However, after reinforcing panel assemblies 1352 are positioned in substantially face-to-face relationship with respective first and second side panels 1314 and 1318, rollover panels 1312 and 1320 are rotated towards interior surface 1304 into substantially face-to-face relationship with at least a portion of respective first reinforcing side panels 1356 to form side walls 1404 and 1406. Thus, rollover panels 1312 and 1320 facilitate securing second reinforcing side panels 1358 between first reinforcing side panels 1356 and respective first and second side panels 1314 and 1318.

In the example embodiment, after container 1400 is formed, connector panels 1380 extend above a top edge of respective reinforcing side panel assemblies 1352 and are oriented substantially parallel to bottom wall 1402. Moreover, stacking tabs 1372 extend through clearance slots 1388. In alternative embodiments, connector panels 1380 and or stacking tabs 1372 are oriented and/or positioned in any suitable fashion that enables container 1400 to function as described herein.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A blank of sheet material for forming a container, the blank comprising:
a bottom panel;
two opposing side panels, each side panel extending from a side edge of the bottom panel;
two opposing end panel assemblies, each end panel assembly extending from an end edge of the bottom panel, wherein each end panel assembly comprises:
an outer end panel extending from the end edge; and
an inner end panel extending from a top edge of the outer end panel; and
a plurality of reinforcing side panel assemblies, each reinforcing side panel assembly extending from a side edge of one of the end panel assemblies, wherein each reinforcing side panel assembly comprises:
a first reinforcing side panel extending from the inner end panel of the respective end panel assembly; and
a second reinforcing side panel extending from the first reinforcing side panel and the outer end panel of the respective end panel assembly.

2. The blank in accordance with claim 1, wherein the end panel assemblies and the reinforcing side panel assemblies are configured to define at least a double wall thickness around a perimeter of the container when formed.

3. The blank in accordance with claim 1, wherein the second reinforcing side panel is coupled to the first reinforcing side panel and the outer end panel.

4. The blank in accordance with claim 1 further comprising a perforation line extending between the first reinforcing side panel and the inner end panel.

5. The blank in accordance with claim 1, wherein each reinforcing side panel assembly further comprises a first score line extending between the first and second reinforcing side panels, and each end panel assembly further comprises a second score line extending between the outer and inner end panel.

6. The blank in accordance with claim 1 further comprising a cutout relief opening defined at an interface between the outer and inner end panels and the first and second reinforcing side panels.

7. The blank in accordance with claim 6, wherein the cutout relief opening extends towards an outer edge of each end panel assembly.

8. The blank in accordance with claim 1 further comprising a locking mechanism that comprises:
at least one stacking tab defined in each end panel assembly; and
a locking slot defined in a top panel of the blank and sized to selectively engage the at least one stacking tab.

9. The blank in accordance with claim 1 further comprising a securing flap panel extending from the top edge of the outer end panel.

10. The blank in accordance with claim 1 further comprising a top panel extending from a first edge of at least one of the opposing side panels.

11. The blank in accordance with claim 1 further comprising a rollover panel extending from a plurality of connector panels coupled to at least one of the opposing side panels.

12. A container formed from a blank of sheet material, the container comprising:
a bottom wall;
two opposing end walls, each end wall comprising an outer end panel emanating from an end edge of the bottom wall and an inner end panel emanating from a top edge of the outer end panel, wherein the inner end panel is coupled to the outer end panel in substantially face-to-face relationship;
two opposing side walls, a first of the side walls comprising a side panel emanating from a side edge of the bottom panel, a first reinforcing side panel emanating from a side edge of the inner end panel of a first of the end walls, and a second reinforcing side panel emanating from the first reinforcing side panel and the outer end panel of the first end wall, wherein the second reinforcing side panel is coupled between the first reinforcing side panel and the side panel.

13. The container in accordance with claim 12, wherein the first side wall further comprises a third reinforcing side panel emanating from a side edge of the inner end panel of a second of the end walls, and a fourth reinforcing side panel emanating from the third reinforcing side panel and the outer end panel of the second end wall, such that the first, second, third, and fourth reinforcing side panels cooperate to define at least a double wall thickness along a length of the first side wall.

14. The container in accordance with claim 13, wherein the blank is fabricated from a corrugated paperboard material comprising a plurality of flutes extending in a direction such that the plurality of flutes in the first, second, third, and fourth reinforcing side panels are oriented substantially vertically relative to the bottom wall.

15. The container in accordance with claim 12, wherein the second reinforcing side panel is affixed between the first reinforcing side panel and the side panel.

16. The container in accordance with claim 12 further comprising a perforation line extending between the first reinforcing side panel and the inner end panel.

17. The container in accordance with claim 12 further comprising:
a first score line extending between the first and second reinforcing side panels; and
a second score line extending between the outer and inner end panel of the first end wall.

18. The container in accordance with claim 12 further comprising a cutout relief opening defined at an interface between the outer and inner end panel of the first end wall and the first and second reinforcing side panels.

19. The container in accordance with claim 18, wherein the cutout relief opening extends towards an outer edge of the inner end panel of the first end wall.

20. The container in accordance with claim 12 further comprising a top panel extending from a first edge of at least one of the opposing side panels.

21. The container in accordance with claim 12, wherein the two opposing end walls and the two opposing side walls cooperate to define at least a double wall thickness around a perimeter of the container.

22. The container in accordance with claim 12, wherein the first side wall further comprises a rollover panel in substantially face-to-face relationship with at least a portion of the first reinforcing side panel.

23. The container in accordance with claim 22, wherein the rollover panel emanates from the first side panel via a plurality of connector panels.

24. The container in accordance with claim 23, wherein each of the plurality of connector panels is oriented substantially parallel with the bottom wall.

25. A method for forming a container from a blank of sheet material, the blank including a bottom panel, two opposing side panels each extending from a side edge of the bottom panel, two opposing end panel assemblies each extending from an end edge of the bottom panel, and a plurality of reinforcing side panel assemblies each extending from a side edge of one of the end panel assemblies, wherein each end panel assembly comprises an outer end panel extending from the end edge and an inner end panel extending from a top edge of the outer end panel, and wherein each reinforcing side panel assembly comprises a first reinforcing side panel extending from the inner end panel and a second reinforcing side panel extending from the first reinforcing side panel and the outer end panel of the respective end panel assembly, the method comprising:
rotating inwardly each end panel assembly such that each end panel assembly is substantially perpendicular to the bottom panel;
rotating inwardly each inner end panel into substantially face-to-face relationship with the outer end panel of the respective end panel assembly;
rotating each reinforcing side panel assembly to extend substantially along one of the side edges of the bottom panel; and
coupling each of the side panels to two of the reinforcing side panel assemblies to form the container.

26. The method in accordance with claim 25, wherein rotating each reinforcing side panel assembly to extend substantially along one of the side edges of the bottom panel further comprises defining at least a double wall thickness around a perimeter of the container.

27. The method in accordance with claim 25, wherein rotating inwardly each inner end panel into substantially face-to-face relationship with the outer end panel of the respective end panel assembly further comprises rotating each inner end panel about a score line defined between the inner end panel and the outer end panel of the respective end panel assembly.

28. The method in accordance with claim 25, wherein rotating inwardly each inner end panel into substantially face-to-face relationship with the outer end panel of the respective end panel assembly further comprises rotating each first reinforcing side panel about a score line defined between the first reinforcing side panel and a respective one of the second reinforcing side panels into substantially face-to-face relationship with the respective second reinforcing side panel.

29. The method in accordance with claim 25, wherein the blank is fabricated from a corrugated paperboard material comprising a plurality of flutes, the method further comprising orienting the flutes of each reinforcing side panel assembly substantially vertically relative to a bottom wall of the container.

30. The method in accordance with claim 25, wherein coupling each of the side panels to the two of the reinforcing side panel assemblies further comprises affixing each second reinforcing side panel between a respective one of the first reinforcing side panels and the respective side panel.

31. The method in accordance with claim 25, wherein the blank further includes a rollover panel extending from a plurality of connector panels coupled to one of the opposing side panels, the method further comprising rotating inwardly the rollover panel into substantially face-to-face relationship with the respective two of the reinforcing side panel assemblies.

32. The method in accordance with claim 31, wherein rotating inwardly the rollover panel further comprises orienting each of the plurality of connector panels substantially parallel to a bottom wall of the container.
